(19) United States
(12) Patent Application Publication
(10) Pub. No.: US 2007/0109667 A1
(43) Pub. Date: May 17, 2007

(54) Optical focus system and zoom system including at least one deformable mirror therein

(76) Inventor: Chen-Wei Chiu, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/467,048

(22) Filed: Aug. 24, 2006

Related U.S. Application Data
(63) Continuation-in-part of application No. 11/423,617, filed on Jun. 12, 2006.
(60) Provisional application No. 60/711,077, filed on Aug. 25, 2005.

(51) Int. Cl. G02B 17/00

(52) U.S. Cl. 359/726

(57) ABSTRACT

An optical zoom system for imaging an object on an image-sensing element comprises at least one first passive optical element disposed on a light traveling path for changing the light direction, at least two deformable mirrors having variable focal lengths and disposed on the light traveling path, and at least one passive optical element disposed on the light traveling path for collecting and correcting the light to image the object on the image-sensing element.

### CROSS-REFERENCE TO RELATED APPLICATIONS

This application claims the benefit of U.S. provisional application Ser. No. 60/711,077 filed on Aug. 25, 2005 and is a continuation-in-part of U.S. application Ser. No. 11/423,617, filed on Jun. 12, 2006, which is a non-provisional application of U.S. provisional Patent Application Ser. No. 60/689,565 filed on Jun. 13, 2005, with the entire disclosures incorporated herein by reference.

### FIELD OF THE INVENTION

The present invention relates generally to the field of optical focus system and optical zoom system, and, more particularly, to optical focus system and optical zoom system including at least one deformable mirror therein.

### Description of Related Art

The miniature mirror fabricated by Micro-Electro-Mechanical Systems (MEMS) technology has been widely employed in various optical devices and the applications thereof, such as projectors, projection TVs, and optical switches . . . etc. However, not many miniature mirrors have been employed in the image capturing system, such as a camera, to provide the functions of such as focusing, zooming in, and zooming out. In order to focus, to zoom in, or to zoom out, traditional devices use motors to move lenses, and they generally occupy large space of the image system.

MEMS devices are compact and precise, which therefore are suitable to replace the motors and lenses for such applications. There have been many MEMS deformable mirrors made to change the focuses of incident light. Due to the mechanical properties of most semiconductor materials, however, the sizes of mirrors are always very small, and the variations of focal lengths are limited as well. Consequently, these traditional MEMS mirrors cannot be used for image applications because such applications require large apertures and sufficient focusing power.

An optical zoom system can vary magnification or focal length while keeping the image plane stationary. Conventional technology requires a continuous mechanical zoom system consisting of multiple optical elements and use fine mechanical motor to precisely adjust the relative position of individual or group lenses. Mechanical zoom systems, such as those found in 35 mm cameras, may take hundreds of milliseconds to vary magnification and may be restricted to magnifying on an optical axis (i.e. the optical axis must be in a line without any angle). Discrete zoom systems have been developed that may vary magnification by rotating lenses or group of lenses in and out of on the optical axis that magnification adjustment is not continuous. Digital or electronic zoom, which is extremely fast and is not limited to on-axis magnification, typically having individual pixels on the focal plane array is simply remapped to larger areas in the display. Thus, the image may be bigger, but the resolution would be reduced.

In U.S. Pat. No. 6,870,688, referring to FIG. 1, an example of a prior art optical zoom system based on lens-moving configuration is disclosed. FIG. 1 is a sectional view showing lens arrangements of a zoom lens system, together with the movement of each lens group when the state of lens group positions varies from the wide-angle end state W to the telephoto end state T through a certain intermediate focal length state M. The zoom lens system is composed of, in order from an object along an optical axis, a fist lens group G1 having negative refractive power, a second lens group G2 having positive refractive power, and a third lens group G3 having positive refractive power.

In FIG. 1, when the state of lens group positions varies from a wide-angle end state W to a telephoto end state T, the space between the first lens group G1 and the second lens group G2 decreases. Moreover, the third lens group G3 is arranged to the image side of the second lens group G2. When the state of the lens group positions varies from W to T, the third lens group G3 is substantially fixed relative to the image plane. The configuration showed in FIG. 1 requires an optical axis in a line, which requires a larger space to vary.

In U.S. Pat. No. 6,977,777, it discloses an active optical zoom system. The prior invention targets for surveillance and remote sensing with very long distance, so it requires very small field of view (such as about 5 degree) for imaging. Though it uses 2 deformable mirrors in the U.S. Pat. No. 6,977,777, its overall system length for this design is still about 60 cm. Besides, the prior invention uses beam splitters to enable light to pass through to mirrors and transported to the next optical element in the optical train. The beam splitters may split the light into reflection and penetration. Thus, not only the power of light arrived on the image plane will be reduced, but also the field of view will be narrowed.

For the foregoing reasons, there is a need for an improved optical focus system and optical zoom system including a deformable mirror therein that can have better compact size and better deformation range to vary the focal length as desired.

### SUMMARY OF THE INVENTION

It is therefore an objective of the present invention to provide an optical focus system including at least one deformable mirror therein for wide field of view and compact overall size.

It is another objective of the present invention to provide an optical zoom system including at least one deformable mirror therein for wide field of view and compact overall size.

It is still another objective of the present invention to provide a camera system including at least one deformable mirror therein for wide field of view and compact overall size.

In accordance with the foregoing and one objective of the present invention, an optical focus system is provided. The optical focus system comprises a deformable mirror having variable focal length disposed on a light traveling path, at least one first passive optical element disposed on the light traveling path for changing the light direction, and at least one second passive optical element disposed on the light traveling path for collecting and correcting the light to image an object on an image-sensing element.

In accordance with another objective of the present invention, the optical zoom system for imaging an object on a image-sensing element comprises at least one first passive optical element disposed on a light traveling path for changing the light direction, at least two deformable mirrors having variable focal lengths and disposed on the light traveling path, and at least one second passive optical element disposed on the light traveling path for collecting and correcting the light to image the object on the image-sensing element.

A camera system comprising at least one first passive optical element disposed on a light traveling path for changing the light direction, at least two deformable mirrors having variable focal lengths and disposed on the light traveling path, at least one second passive optical element disposed on the light traveling path for collecting and correcting the light to image an object, an image-sensing element disposed on the light traveling path for receiving the object image thereon, and a data processing unit electronically connecting with the image-sensing element for processing the object image and output the object image.

Preferably, in the present invention, the at least one first passive optical element may comprise at least one prism and/or at least one mirror. Furthermore, the at least one first passive optical element may have function of total internal reflection (TIR) for wide field of view and compact overall size. The at least one second passive optical element may comprise a lens or a group of lens. Moreover, the optical systems, including the focus system, zoom system, and the camera system, may further respectively comprise an electronic circuit connecting to the deformable mirror to supply a voltage for the deformable mirror having variable focal lengths. In addition, the optical systems may respectively further comprise a plurality of electrodes forming in concentric circle shape for the at least one deformable mirror to have a spherical or aspheric contour.

In one embodiment of the present invention, the deformable mirror comprises an upper portion comprising an organic thin film and a reflecting layer disposed on a lower surface and/or on an upper surface of the organic thin film, a lower portion comprising a conductive substrate, and a spacer disposed between the upper portion and the lower portion. When the voltage is applied on the deformable mirror, its focal lengths may be varied.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a sectional view showing lens arrangements of a zoom lens system;

FIG. 2 illustrates an optical focus system according to one preferred embodiment of the present invention;

FIG. 3 illustrates another optical focus system according to one preferred embodiment of the present invention;

FIG. 4 illustrates an optical zoom system according to an embodiment of the present invention;

FIG. 5 illustrates an optical digital system according to another preferred embodiment of the present invention;

FIG. 6 is a cross-sectional diagram illustrating a miniature deformable mirror according one preferment embodiment of the present invention; and

FIG. 7 is a schematic diagram illustrating the shape of electrode to control the deformation contour of the deformable mirrors.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or the like parts.

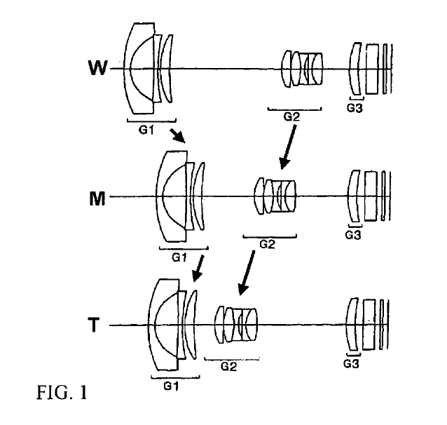

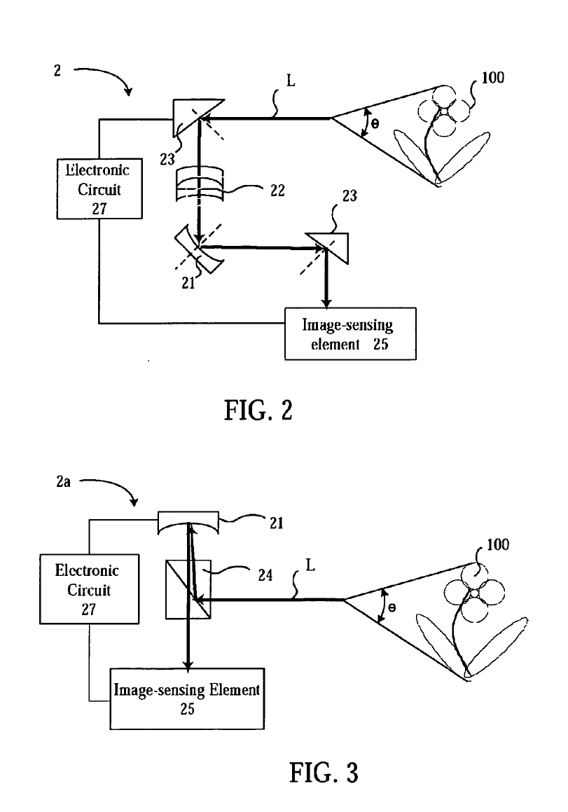

The optical focus system according to the present invention comprises a deformable mirror, at least one first passive optical element such as prism and/or mirror for changing the light direction, and at least one second passive optical element such as lens(es) for collecting and correcting the light to image an object on an image-sensing element. For example, please refer to FIG. 2, which illustrates an optical focus system according to one preferred embodiment of the present invention. The optical focus system 2 comprises a deformable mirror 21, at least one first passive optical element such as prisms 23 to change the direction of the light L, and at least one second passive optical element such as a group of lens 22 disposed on the light L traveling path for collecting and correcting the light to image an object 100 on an imaging-sensing element 25. The lens 22, such as solid lens, usually has a fixed focal length after manufacturing. Though the lens 22 is disposed between the deformable mirror 21 and the prism 23, it may be varied by different configuration. For example, the lens 22 may be disposed between the prism 23 and the object 100, or the lens 22 may be disposed between the prism 23 and the image-sensing element 25, or any combination thereof. And, each prism 23 can be used for changing the direction of the light L. Though it shows two prisms 23 in FIG. 1, which should not be used to limit the present invention. The configuration of the embodiment of the present invention is used to make the light L traveling from the object 100 to the image-sensing element 25 such as charge-coupled device (CCD), film, or the like.

Typically, when an object is disposed very close to a camera, it cannot be focused properly on the image-sensing element. This results in blurred image outputs. In order to have the projection of the object 100 onto the image-sensing element 25 properly, the deformable mirror 21 is disposed on the light traveling path to adjust the focal length thereof. In a preferred embodiment, the optical focus system 2 may further comprise an electronic circuit 27 connecting to the deformable mirror 21 to supply a voltage for the deformable mirror 21 varying focal lengths. In this manner, the projection of the object 100 can be fell right on the image-sensing element 25, and a sharp and focused image output can be created.

FIG. 3 illustrates another optical focus system 2a according to one preferred embodiment of the present invention. In this embodiment, it uses total internal reflection (TIR) to change the light L direction. As skilled in this art will be appreciated, the TIR can be achieved by using at least one prism, thus, it is not necessary to discuss more detail for the function or the theory of the TIR. In FIG. 3, a TIR device 24 is adopted to change the light L direction. And as description in above, similarly, the deformable mirror 21 can vary the focal length thereof by the voltage supplied from the electronic circuit 27 to image the object 100 onto the image-sensing element 25. Moreover, FIG. 3 is describing about the TIR device application, thus, the lens 22 shown in FIG. 2 is not shown in FIG. 3, which is not used to limit the present invention as skilled in this art will be understood.

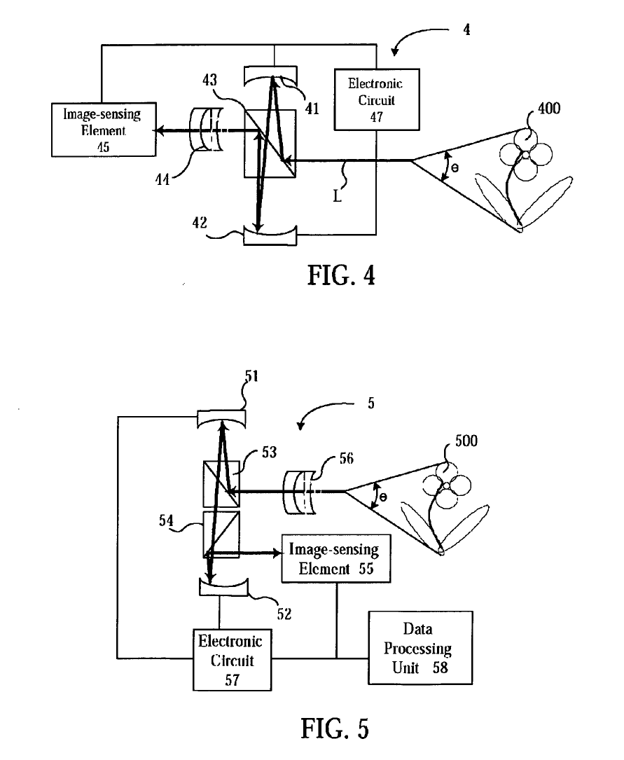

An optical zoom system according to an embodiment of the present invention for imaging an object on a image-sensing element comprises at least one first passive optical element such as prism(s), mirror(s), TIR device(s), or the like for changing the light direction, at least two deformable mirrors for varying focal lengths, and at least one second passive optical element such as lens(es) or group(s) of lens for collecting and correcting the light. FIG. 4 illustrates one example embodiment of the optical zoom system according to the present invention. The optical zoom system 4 comprises at least two deformable mirrors 41, 42, at least one first passive optical element such as a TIR device 43, and at least one second passive optical element such as a group of lens 44 for imaging an object 400 on an imaging-sensing element 45. An electronic circuit 47 is connected to the deformable mirrors 41 and 42 to supply a voltage for the deformable mirrors 41 and 42 varying focal lengths thereof. The lens 44, such as solid lens, usually has a fixed focal length after manufacturing. Though the lens 44 is disposed between the TIR device 43 and the image-sensing element 45, it may be varied by different configuration. For example, the lens 44 may be disposed between the deformable mirror 41 or 42 and the TIR device 43, or the lens 44 may be disposed between the TIR device 43 and the object 400, or any combination thereof. And, the TIR device 43 can be used for changing the direction of the light L.

In order to have the function of zooming, for example, the deformable mirrors 41 and 42 have to be disposed on the light L traveling path, and both of them have to be aligned so that the object 400 can be projected onto the image-sensing element 45 by way of the deformable mirrors 41 and 42 and the TIR device 43. It should be noted that the TIR device 43 may be added for more changing direction, if desired. The electronic circuitry 47 provides adequate voltages to the deformable mirrors 41 and 42 for properly deformation to reflect the light L. The focal lengths of the two deformable mirrors 41 and 42 can therefore be adjusted respectively. Accordingly, the projection enlargement can be configured by the designed focal length ratio of the two deformable mirrors 41 and 42.

An embodiment of a camera system is disclosed in the present invention. The camera system comprises at least one first passive optical element such as prism(s), mirror(s), TIR device(s), or the like for changing the light direction, at least two deformable mirrors for varying focal lengths, at least one second passive optical element such as lens(es) or group(s) of lens for collecting and correcting the light to image an object, an image-sensing element such as a CCD or a film for receiving the object image thereon, and a data processing unit electronically connecting with the image-sensing element for processing the object image and output the object image. For example, as shown in FIG. 5, which illustrates a camera system according to a preferred embodiment of the present invention. The camera system 5 comprises at least two deformable mirrors 51, 52, at least one first passive optical element such as TIR devices 53 and 54, at least one second passive optical element such as lens 56, an imaging-sensing element 55 for imaging an object 500 thereon, and a data processing unit 58 for processing the image projected on the imaging-sensing element 55. An electronic circuit 57 is connected to the deformable mirrors 51 and 52, in a preferred embodiment, to supply a voltage for the deformable mirrors 51 and 52 varying focal lengths thereof. The lens 56, such as solid lens, usually has a fixed focal length after manufacturing. Though the lens 56 is disposed between the TIR device 53 and the object 500, it may be varied by different configuration. For example, the lens 56 may be disposed between the deformable mirror 51 or 52 and the TIR device 53 or 54, or the lens 56 may be disposed between the TIR device 54 and the imaging-sensing element 55, or any combination thereof. And, the TIR device 53 and 54 can be used for changing the direction of the light L to reduce the overall size of the digital camera system.

As description in the above, the camera system 5 also contains functions of zooming and focusing. For focusing function, the there is only one deformable mirror 51 or 52 required in the camera system 5. For zooming, the deformable mirrors 51 and 52 have to be disposed on the light L traveling path, and both of them have to be aligned so that the object 500 can be projected onto the image-sensing element 55 by way of the deformable mirrors 51 and 52 and the TIR device 53 and 54 to change the direction of the light L. The electronic circuitry 57 provides adequate voltages to the deformable mirrors 51 and 52 for properly deformation to reflect the light L. The focal lengths of the two deformable mirrors 51 and 52 can therefore be adjusted respectively. Accordingly, the projection enlargement can be configured by the designated focal length ratio of the two deformable mirrors 51 and 52.

According to the prism 23 or the TIR device 24, 43, 53 or 54, as shown in FIGS. 2-5, the field of view can be wider with minimized aberration. For example, the wide angle θ can be more than 60 degrees. Comparing to the prior art, which beam splitters are used, the field of view is much wider. In addition, the prism(s) or the TIR device(s) can be used for changing the direction of the light L to reduce the overall size.

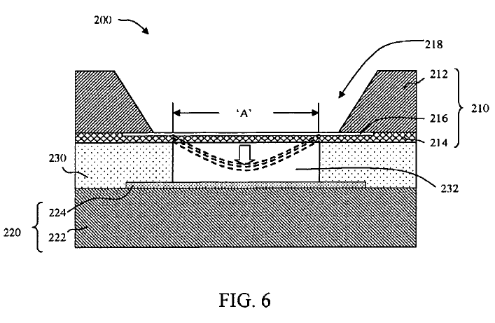

Furthermore, the deformable mirrors 21, 41, 42, 51, and 52, as shown in FIGS. 2-5, may have specific structure. Please refer to the FIG. 6 for more detail about the deformable mirror.

FIG. 6 is a cross-sectional diagram illustrating a miniature deformable mirror according one preferment embodiment of the present invention. The miniature deformable mirror 200 includes an upper portion 210, a lower portion 220, and a spacer 230. The miniature deformable mirror 200 is fabricated by bonding the upper portion 210 and the lower portion 220 with the spacer 230 in between.

The upper portion 21 0 comprises a frame 21 2, an organic thin film 214, and a reflecting layer 216. The frame 212 having a mirror opening 218 supports the organic thin film 214. The frame 212, for example, can be made by silicon substrate. The reflecting layer 216 is disposed on the upper surface of the organic thin film 214. Alternatively, the reflecting layer 216 can also be disposed on the lower surface of the organic thin film 214. Even, the reflecting layer 216 can also be disposed on both of the upper and the lower surfaces of the organic thin film 214.

The lower portion 220 comprises a substrate 222 and a conductive layer 224 disposed on the substrate 222. Alternatively, the substrate 222 may be a conductive substrate without a conductive layer 224 thereon. The substrate 222 can be made of materials typically employed in the semiconductor fabrication, such as silicon, glass, plastic, or gallium arsenide. The conductive layer 224 (or the conductive substrate 222) is used for conducting the applied voltage and can be made of conductive materials, such as aluminum, gold, or indium tin oxide.

The spacer 230 with a desired shape of a spacer opening 232 is sandwiched between the upper portion 210 and the lower portion 220. The actual mirror deflecting area ‘A’ is defined by the spacer opening 232 instead of the mirror opening 218. Therefore, the size and shape of the mirror deflecting area ‘A’ can be adjusted as desired regardless of the shape of the mirror opening 218 initially formed by anisotropic etching. As a result, a more flexible mirror deflecting area ‘A’ can be obtained, which is not restricted to the etching profile of the mirror opening 218. The spacer 230 is used for separation purpose as well and can be made of, for example, photoresist, polyimide, polyethylene, or elastomer, such as polydimethylsiloxane (PDMS). Different from the oxide spacer used in the conventional mirror, the thickness of the spacer 230 can easily achieve tens of micrometers to hundreds of micrometers with the abovementioned materials and the like.

In order to deform the organic thin film 214 and the reflecting layer 216, voltages are applied between the reflecting layer 216 and the conductive layer 224 (or the conductive substrate 222). The reflecting layer 216 and the conductive layer 224 (or the conductive substrate 222) serve as a first and a second electrode respectively, and they can be patterned into different shapes, sizes and numbers of electrodes. The applied voltages generate electrostatic forces to attract the organic thin film 214 and the reflecting layer 216 toward the lower portion 220. Only within the mirror deflecting area ‘A’ of the organic thin film 214 and the reflecting layer 216 toward the lower portion 220 is movable. By varying the shape of the electrode and applied voltages, a desired deformation profile or shape of the organic thin film 214 and the reflecting layer 216 can be obtained.

In addition, though the deformable mirrors 21, 41, 42, 51, and 52 shown in FIG. 2-5 are concave, the deformable mirrors 21, 41, 42, 51, and 52 can be convex by different configuration, if desired, to further reduce the overall size of the optical system, such as the focus, the zoom, or the camera system.

Additional features to the deformable mirrors can be found in the parent application, that is U.S. application Ser. No. 11/423,617.

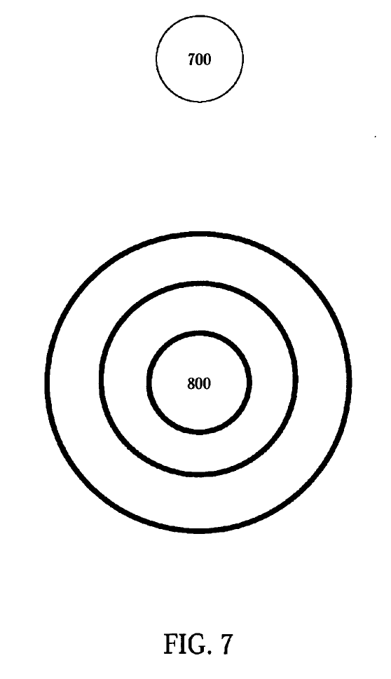

Besides, referring to FIG. 7, in a preferred embodiment of the present invention, the optical system, such as the focus, the zoom, or the camera system, may further comprise a plurality of electrodes 800 forming in concentric circle shape for the deformable mirror to have a spherical or aspheric contour. The shape of the electrodes 700 for pulling the deformable mirrors 200 (shown in FIG. 6) can be varied to control the contour of the deformation of the miniature deformable mirrors 200. For example, the shape of the electrode with single circular can pull the deformable mirror down to form concave or convex mirrors depending upon the direction of incident light. In order to increase the control flexibility, which can result in reducing image aberration, the present invention may use the electrode 800 with concentric circle shape and/or multiple voltage levels to make the deformable mirror have the contour with either spherical or aspheric shape depending upon the magnification. Notably, the miniature deformable mirrors 200 can not only change the zoom ratio, but also correct the image aberration from the optical system, such as the focus, the zoom, or the camera system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical focus system for imaging an object on a image-sensing element comprising:
a deformable mirror having variable focal length and disposed on a light traveling path;
at least one first passive optical element disposed on the light traveling path for changing the light direction; and
at least one second passive optical element disposed on the light traveling path for collecting and correcting the light to image the object on the image-sensing element.

2. The optical focus system of claim 1, wherein the at least one second passive optical element comprises a lens.

3. The optical focus system of claim 1, wherein the at least one first passive optical element comprises at least one prism or mirror.

4. The optical focus system of claim 3, wherein the at least one first passive optical element have the function of total internal reflection (TIR).

5. The optical focus system of claim 1, wherein the deformable mirror comprises:
an upper portion comprising an organic thin film and a reflecting layer disposed on a lower surface or on an upper surface of the organic thin film;
a lower portion comprising a conductive substrate; and
a spacer disposed between the upper portion and the lower portion.

6. The optical focus system of claim 1 further comprising a plurality of electrodes forming in concentric circle shape for the deformable mirror to have a spherical or aspheric contour.

7. The optical focus system of claim 1 further comprising an electronic circuit connecting to the deformable mirror to supply a voltage for the deformable mirror having variable focal lengths.

8. An optical zoom system for imaging an object on a image-sensing element comprising:
at least one first passive optical element disposed on a light traveling path for changing the light direction;
at least two deformable mirrors having variable focal lengths and disposed on the light traveling path; and
at least one second passive optical element disposed on the light traveling path for collecting and correcting the light to image the object on the image-sensing element.

9. The optical zoom system of claim 8, wherein the at least one first passive optical element comprises at least one prism or mirror.

10. The optical zoom system of claim 8, wherein the at least one second passive optical element comprises a lens.

11. The optical zoom system of claim 9, wherein the at least one first passive optical element have the function of total internal reflection (TIR).

12. The optical zoom system of claim 8, wherein the at least one deformable mirror comprises:
an upper portion comprising an organic thin film and a reflecting layer disposed on a lower surface or on an upper surface of the organic thin film;
a lower portion comprising a conductive substrate; and
a spacer disposed between the upper portion and the lower portion.

13. The optical zoom system of claim 8,further comprising a plurality of electrodes forming in concentric circle shape for the at least one deformable mirror to have a spherical or aspheric contour.

14. The optical zoom system of claim 8 further comprising an electronic circuit connecting to the at least one deformable mirror to supply a voltage for the at least one deformable mirror having variable focal lengths.

15. A camera system comprising:
at least one first passive optical element disposed on a light traveling path for changing the light direction;
at least one deformable mirrors having variable focal lengths and disposed on the light traveling path;
at least one second passive optical element disposed on the light traveling path for collecting and correcting the light to image an object;
an image-sensing element disposed on the light traveling path for receiving the object image thereon; and
a data processing unit electronically connecting with the image-sensing element for processing the object image and output the object image.

16. The camera system of claim 15, wherein the at least one first passive optical element comprises at least one prism or mirror.

17. The camera system of claim 16, wherein the at least one first passive optical element have the function of total internal reflection (TIR).

18. The camera system of claim 15, wherein the at least one deformable mirror comprises:
an upper portion comprising an organic thin film and a reflecting layer disposed on a lower surface or on an upper surface of the organic thin film;
a lower portion comprising a conductive substrate; and
a spacer disposed between the upper portion and the lower portion.

19. The camera system of claim 15 further comprising a plurality of electrodes forming in concentric circle shape for the at least one deformable mirror to have a spherical or aspheric contour.

20. The camera system of claim 15 further comprising an electronic circuit connecting to the at least one deformable mirror to supply a voltage for the at least one deformable mirror having variable focal lengths.
